(19) United States
(12) Patent Application Publication
(10) Pub. No.: US 2006/0216570 A1
(43) Pub. Date: Sep. 28, 2006

(54) Durable hydrophilic coatings for fuel cell bipolar plates

(76) Inventors: Gayatri Vyas, Rochester Hills, MI (US); Richard H. Blunk, Macomb Township, MI (US); Thomas A. Trabold, Pittsford, NY (US); Reena L. Datta, Rochester, NY (US); Keith E. Newman, Pittsford, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/089,525

(22) Filed: Mar. 24, 2005

(51) Int. Cl. H01M 8/02; H01M 8/08; B05D 5/12

(52) U.S. Cl. 429/38; 429/46; 427/115

(57) ABSTRACT

A flow field plate for a fuel cell that includes an outer layer of a metal oxide or other material that makes the plate hydrophilic. The particular metal oxide and the thickness of the metal oxide layer are selected so that hydrofluoric acid generated by the fuel cell continuously etches away the layer at a predetermined rate so that a surface of the layer is free of contaminants over the entire life of the fuel cell. If the fuel cell does not employ a perfluorosulfonic acid membrane, then a separate hydrofluoric acid source can be provided that injects a low level solution of hydrofluoric acid into one or both of the reactant gas streams.

### BACKGROUND OF THE INVENTION

1. Field of the Invention

This invention relates generally to bipolar plates for fuel cells and, more particularly, to a bipolar plate for a fuel cell that includes an outer coating that makes the plate hydrophilic, and degrades in the presence of hydrofluoric acid to continuously expose a clean hydrophilic surface during operation of the fuel cell.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode. The work acts to operate the vehicle.

Proton exchange membrane fuel cells (PEMFC) are a popular fuel cell for vehicles. The PEMFC generally includes a solid-polymer-electrolyte proton-conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Several fuel cells are typically combined in a fuel cell stack to generate the desired power. For the automotive fuel cell stack mentioned above, the stack may include about two hundred bipolar plates. The fuel cell stack receives a cathode reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack.

The fuel cell stack includes a series of flow field or bipolar plates positioned between the several MEAs in the stack. The bipolar plates include an anode side and a cathode side for adjacent fuel cells in the stack. Anode gas flow channels are provided on the anode side of the bipolar plates that allow the anode gas to flow to the anode side of the MEA. Cathode gas flow channels are provided on the cathode side of the bipolar plates that allow the cathode gas to flow to the cathode side of the MEA. The bipolar plates also include flow channels through which a cooling fluid flows.

The bipolar plates are typically made of a conductive material, such as stainless steel, titanium, aluminum, polymeric carbon composites, etc., so that they conduct the electricity generated by the fuel cells from one cell to the next cell and out of the stack. Metal bipolar plates typically produce a natural oxide on their outer surface that makes them resistant to corrosion. However, the oxide layer is not conductive, and thus increases the internal resistance of the fuel cell, reducing its electrical performance. Also, the oxide layer makes the plate more hydrophobic.

US Patent Application Publication No. 2003/0228512, assigned to the assignee of this application and herein incorporated by reference, discloses a process for depositing a conductive outer layer on a flow field plate that prevents the plate from oxidizing and increasing its ohmic contact. U.S. Pat. No. 6,372,376, also assigned to the assignee of this application, discloses depositing an electrically conductive, oxidation resistant and acid resistant coating on a flow field plate. US Patent Application Publication No. 2004/0091768, also assigned to the assignee of this application, discloses depositing a graphite and carbon black coating on a flow field plate for making the flow field plate corrosion resistant, electrically conductive and thermally conductive.

As is well understood in the art, the membranes within a fuel cell need to have a certain relative humidity so that the ionic resistance across the membrane is low enough to effectively conduct protons. During operation of the fuel cell, moisture from the MEAs and external humidification may enter the anode and cathode flow channels. At low cell power demands, typically below 0.2 A/cm², the water accumulates within the flow channels because the flow rate of the reactant gas is too low to force the water out of the channels. As the water accumulates, it forms droplets that continue to expand because of the hydrophobic nature of the plate material. The contact angle of the water droplets is generally about 90° in that the droplets form in the flow channels substantially perpendicular to the flow of the reactant gas. As the size of the droplets increases, the flow channel is closed off, and the reactant gas is diverted to other flow channels because the channels flow in parallel between common inlet and outlet manifolds. Because the reactant gas may not flow through a channel that is blocked with water, the reactant gas cannot force the water out of the channel. Those areas of the membrane that do not receive reactant gas as a result of the channel being blocked will not generate electricity, thus resulting in a non-homogenous current distribution and reducing the overall efficiency of the fuel cell. As more and more flow channels are blocked by water, the electricity produced by the fuel cell decreases, where a cell voltage potential less than 200 mV is considered a cell failure. Because the fuel cells are electrically coupled in series, if one of the fuel cells stops performing, the entire fuel cell stack may stop performing.

It is usually possible to purge the accumulated water in the flow channels by periodically forcing the reactant gas through the flow channels at a higher flow rate. However, on the anode side, this increases the parasitic power applied to the air compressor, thereby reducing overall system efficiency. Moreover, there are many reasons not to use the hydrogen fuel as a purge gas, including reduced economy, reduced system efficiency and increased system complexity for treating elevated concentrations of hydrogen in the exhaust gas stream.

Reducing accumulated water in the channels can also be accomplished by reducing inlet humidification. However, it is desirable to provide some relative humidity in the anode and cathode reactant gases so that the membrane in the fuel cells remains hydrated. A dry inlet gas has a drying effect on the membrane that could increase the cell's ionic resistance, and limit the membrane's long-term durability.

It has been proposed by the present inventors to make bipolar plates for a fuel cell hydrophilic to improve channel water transport. A hydrophilic plate causes water in the channels to form a thin film that has less of a tendency to alter the flow distribution along the array of channels connected to the common inlet and outlet headers. If the plate material is sufficiently wettable, water transport through the diffusion media will contact the channel walls and then, by capillary force, be transported into the bottom corners of the channel along its length. The physical requirements to support spontaneous wetting in the corners of a flow channel are described by the Concus-Finn condition, β+α/2<90°, where β is the static contact angle and α is the channel corner angle. For a rectangular channel α/2=45°, which dictates that spontaneous wetting will occur when the static contact angle is less than 45°. For the roughly rectangular channels use in current fuel cell stack designs with composite bipolar plates, this sets an approximate upper limit on the contact angle needed to realize the beneficial effects of hydrophilic plate surfaces on channel water transport and low load stability.

A design concern needs to be addressed when providing a hydrophilic coating on bipolar plates in fuel cells. Because hydrophilic coatings have a high surface energy, they will attract particles and other contaminants entering the fuel cell from the gaseous fuel and/or oxygen streams, from humidifiers and upstream piping, or generated internally by other components, such as the MEA, diffusion media, seals, composite plate materials, etc. Accumulation of these contaminants on the coating will, over time, significantly reduce the hydrophilicity of the coating. Even if provisions are made to control contamination through the use of gas filtering and ultra-clean components, it is unlikely that degradation of a hydrophilic coating or other surface treatment would not occur during the desired 6,000 hour lifetime of a fuel cell.

### SUMMARY OF THE INVENTION

In accordance with the teachings of the present invention, a flow field plate or bipolar plate for a fuel cell is disclosed that includes an outer layer of a metal oxide, or other material, that makes the plate hydrophilic. Suitable metal oxides include at least one of SiO₂, HfO₂, ZrO₂, Al₂O₃, SnO₂, Ta₂O₅, Nb₂O₅, MoO₂, IrO₂, RuO₂, metastable oxynitrides, nonstoichiometric metal oxides, oxynitrides and mixtures thereof. The particular metal oxide and the thickness of the metal oxide layer are selected so that hydrofluoric acid generated by the perfluorosulfonic acid membrane in the fuel cell etches away the layer at a desired rate so that a clean surface of the layer is continuously exposed that is free of contaminants over the entire life of the fuel cell. If the fuel cell does not employ a perfluorosulfonic acid membrane, then a separate hydrofluoric acid source can be provided that injects a low level solution of hydrofluoric acid into one or both of the reactant gas streams.

Additional advantages and features of the present invention will become apparent from the following description and appended claims, taken in conjunction with the accompanying drawings.

### BRIEF DESCRIPTION OF THE DRAWINGS

FIG. 1 is a cross-sectional view of a fuel cell in a fuel cell stack that includes bipolar plates having an outer layer that makes the plate hydrophilic, according to an embodiment of the present invention; and

FIG. 2 is a plan view of a fuel cell system including a fuel cell stack and a source of hydrofluoric acid for emitting hydrofluoric acid into a reactant stream of the fuel cell stack.

### DETAILED DESCRIPTION OF THE EMBODIMENTS

The following discussion of the embodiments of the invention directed to a bipolar plate for a fuel cell that includes a coating that makes the bipolar plate hydrophilic and is etched away at a predetermined rate in the hydrofluoric acid environment of the fuel cell.

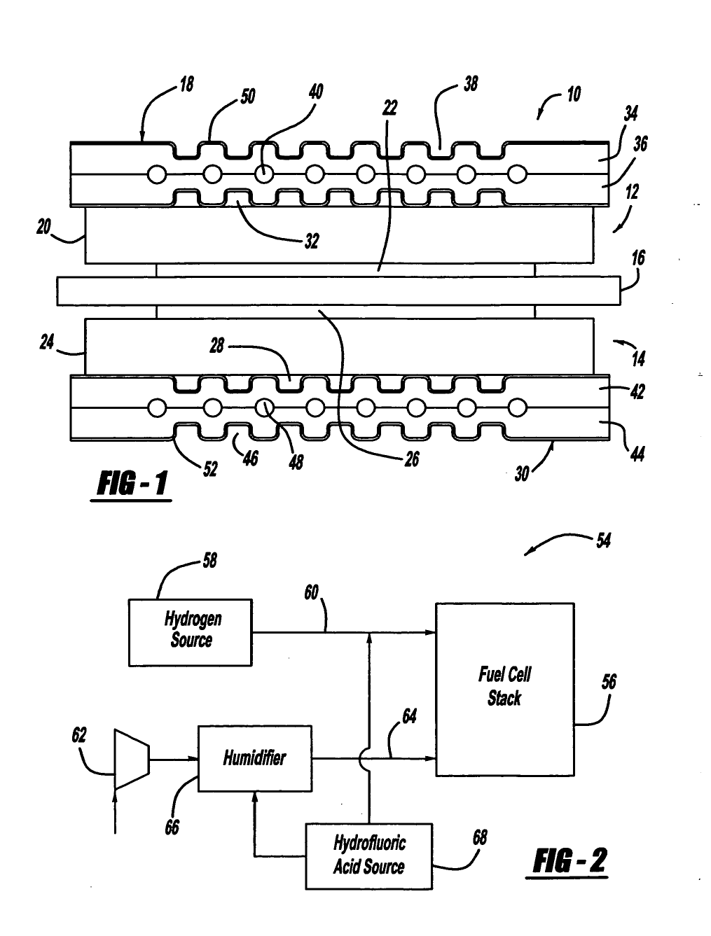

FIG. 1 is a cross-sectional view of a fuel cell 10 that is part of a fuel stack of the type discussed above. The fuel cell 10 includes a cathode side 12 and an anode side 14 separated by a perfluorosulfonic acid membrane 16. A cathode side diffusion media layer 20 is provided on the cathode side 12, and a cathode side catalyst layer 22 is provided between the membrane 16 and the diffusion media layer 20. Likewise, an anode side diffusion media layer 24 is provided on the anode side 14, and an anode side catalyst layer 26 is provided between the membrane 16 and the diffusion media layer 24. The catalyst layers 22 and 26 and the membrane 16 define an MEA. The diffusion media layers 20 and 24 are porous layers that provide for input gas transport to and water transport from the MEA. Various techniques are known in the art for depositing the catalyst layers 22 and 26 on the diffusion media layers 20 and 24, respectively, or on the membrane 16.

A cathode side flow field plate or bipolar plate 18 is provided on the cathode side 12 and an anode side flow field plate or bipolar plate 30 is provided on the anode side 14. The bipolar plates 18 and 30 are provided between the fuel cells in the fuel cell stack. A hydrogen reactant gas flow from flow channels 28 in the bipolar plate 30 reacts with the catalyst layer 26 to dissociate the hydrogen ions and the electrons. Airflow from flow channels 32 in the bipolar plate 18 reacts with the catalyst layer 22. The hydrogen ions are able to propagate through the membrane 16 where they electro-chemically react with the airflow and the return electrons in the catalyst layer 22 to generate water as a by-product.

In this non-limiting embodiment, the bipolar plate 18 includes two sheets 34 and 36 that are stamped and welded together. The sheet 36 defines the flow channels 32 and the sheet 34 defines flow channels 38 for the anode side of an adjacent fuel cell to the fuel cell 10. Cooling fluid flow channels 40 are provided between the sheets 34 and 36, as shown. Likewise, the bipolar plate 30 includes a sheet 42 defining the flow channels 28, a sheet 44 defining flow channels 46 for the cathode side of an adjacent fuel cell, and cooling fluid flow channels 48. In the embodiments discussed herein, the sheets 34, 36, 42 and 44 are made of an electrically conductive material, such as stainless steel, titanium, aluminum, polymeric carbon composites, etc.

According to one embodiment of the invention, the bipolar plates 18 and 30 are coated with a metal oxide layer 50 and 52, respectively, that make the plates 18 and 30 hydrophilic. The layers 50 and 52 can also be made of materials other than metal oxide that make plates 18 and 30 hydrophilic within the scope of the present invention. The hydrophilicity of the layers 50 and 52 causes the water within the flow channels 28 and 32 to form a film instead of water droplets so that the water does not significantly block the flow channel. Particularly, the hydrophilicity of the layers 50 and 52 decreases the contact angle of water accumulating within the flow channels 32, 38, 28 and 46, preferably below 40°, so that the reactant gas is still able to flow through the channels at low loads.

Suitable metal oxides for the layers 50 and 52 include, but care not limited, to silicon dioxide (SiO₂), hafnium dioxide (HfO₂), zirconium dioxide (ZrO₂), aluminum oxide (Al₂O₃), stannic oxide (SnO₂), tantalum pent-oxide (Ta₂O₅), niobium pent-oxide (Nb₂O₅), molybdenum dioxide (MoO₂), iridium dioxide (IrO₂), ruthenium dioxide (RuO₂), metastable oxynitrides, nonstoichiometric metal oxides, oxynitrides and mixtures thereof.

Before the layers 50 and 52 are deposited on the bipolar plates 18 and 30, the bipolar plates 18 and 30 are cleaned by a suitable process, such as ion beam sputtering, to remove the resistive oxide film on the outside of the plates 18 and 30 that may have formed. The metal oxide material can be deposited on the bipolar plates 18 and 30 by any suitable technique including, but not limited to, physical vapor deposition processes, chemical vapor deposition (CVD) processes, thermal spraying processes and sol-gel. Suitable examples of physical vapor deposition processes include electron beam evaporation, magnetron sputtering and pulsed plasma processes. Suitable chemical vapor deposition processes include plasma enhanced CVD and atomic layer deposition processes.

As is understood in the art, hydrofluoric acid (HF) is generated as a result of degradation of the perfluorosulfonic ionomer in the membrane 16 during operation of the fuel cell. The hydrofluoric acid has a corrosive effect on the various coating materials discussed herein because it etches away the metal oxide layers 50 and 52. The etching of the layers 50 and 52 is desirable because a clean surface of the layers 50 and 52 that is free of contaminants is continuously exposed during operation of the fuel cell 10. Therefore, the desired hydrophilicity of the layers 50 and 52 is maintained.

The thickness of the layers 50 and 52 needs to be sufficient to handle the degradation caused by the fluoride ions in the hydrofluoric acid over the desired lifetime of the fuel cell 10 without being completely etched away. In one embodiment, the desired lifetime of the fuel cell 10 is about 6000 hours. The necessary thickness of the layers 50 and 52 is dependent on the layer material. In other words, the layers 50 and 52 need to be thicker for materials that are quickly etched away by the hydrofluoric acid and the layers 50 and 52 can be thinner for materials that are slowly etched away by the hydrofluoric acid. In one non-limiting embodiment, the layers 50 and 52 are 80-100 nm thick. Certain of the suitable metal oxide materials, such as ZrO₂, are more resistant to the fluoride ions, and still provide the desired hydrophilicity, which could be more desirable in certain fuel cell stacks. Moreover, ZrO₂ acts as a scavenger of fluoride ions, further enhancing its durability in applications involving stainless steel.

FIG. 2 is block diagram of a fuel cell system 54 including a fuel cell stack 56. A hydrogen source 58 provides a hydrogen reactant gas input on an anode input line 60 that is sent to the anode side of the fuel cells within the fuel cell stack 56. A compressor 62 provides compressed air on a cathode side input line 64 that is sent to the cathode side of the fuel cells in the fuel cell stack 56. A humidifier 66 humidifies the air before it is input into the fuel cell stack 56 to provide increased cell membrane humidity. In this embodiment, the fuel cells in the fuel cell stack 56 do not have a perfluorosulfonic acid membrane, but use other types of membranes known in the art, such as the hydrocarbon based membrane. Therefore, the membranes in the fuel cell stack 56 do not generate hydrofluoric acid to etch away the layers 50 and 52 to maintain the hydrophilicity of the layers 50 and 52, as discussed above. According to this embodiment of the invention, a hydrofluoric acid source 68 is provided that provides a controlled amount of low level hydrofluoric acid to one or both of the reactant gas input lines 60 and 64. The concentration of the hydrofluoric acid is determined for the desired etch rate of the metal oxide layers, which is based on the metal oxide material and the thickness of the layers, as discussed above. Additionally, the hydrofluoric acid from the source 68 can be applied to the humidifier 66.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell comprising a flow field plate being made of a plate material, said flow field plate including a plurality of flow channels responsive to a reactant gas, said flow field plate further including an outer layer that makes the flow field plate hydrophilic, wherein the material of the outer layer and the thickness of the outer layer are selected so that hydrofluoric acid within the fuel cell etches away an outer surface of the layer at a desirable rate so that a clean surface of the outer layer is continuously exposed, but the outer layer is not completely etched away over a predetermined lifetime of the fuel cell.

2. The fuel cell according to claim 1 wherein the plate material comprises at least one of stainless steel, titanium, aluminum, alloys thereof, and a polymer-composite based material.

3. The fuel cell according to claim 1 wherein the outer layer is a metal oxide layer.

4. The fuel cell according to claim 4 wherein the metal oxide comprises at least one of SiO₂, HfO₂, ZrO₂, Al₂O₃, SnO₂, Ta₂O₅, Nb₂O₅; MoO₂, IrO₂, RuO₂, metastable oxynitrides, nonstoichiometric metal oxides, oxynitrides and mixtures thereof.

5. The fuel cell according to claim 1 wherein the outer layer is between 80-100 nm thick.

6. The fuel cell according to claim 1 wherein the predetermined lifetime of at least 6000 hours.

7. The fuel cell according to claim 1 further comprising a perfluorosulfonic acid membrane that generates the hydrofluoric acid.

8. The fuel cell according to claim 1 further comprising a source of hydrofluoric acid external to the fuel cell, said source of hydrofluoric acid providing the hydrofluoric acid to the reactant gas prior to the reactant gas entering the fuel cell.

9. The fuel cell according to claim 1 wherein the flow field plate is selected from the group consisting of anode-side flow field plates and cathode-side flow field plates.

10. The fuel cell according to claim 1 wherein the fuel cell is part of a fuel cell stack on a vehicle.

11. A fuel cell comprising:
a perfluorosulfonic acid membrane that generates hydrofluoric acid; and
a flow field plate being made of a plate material, said flow field plate including a plurality of flow channels responsive to a reactant gas, said flow field plate further including an outer metal oxide layer that makes the flow field plate hydrophilic, wherein the particular metal oxide in the metal oxide layer and the thickness of the metal oxide layer are selected so that the hydrofluoric acid etches away an outer surface of the layer at a desirable rate so that a clean surface of the layer is continuously exposed, but the layer is not completely etched away over a predetermined lifetime of the fuel cell.

12. The fuel cell according to claim 11 wherein the plate material is selected from the group consisting of stainless steel, titanium, aluminum and a polymer-composite based material.

13. The fuel cell according to claim 11 wherein the metal oxide comprises at least one of SiO₂, HfO₂, ZrO₂, Al₂O₃, SnO₂, Ta₂O₅, Nb₂O₅, MoO₂, IrO₂, RuO₂, metastable oxynitrides, nonstoichiometric metal oxides, oxynitrides and mixtures thereof.

14. The fuel cell according to claim 11 wherein the metal oxide layer is between 80-100 nm thick.

15. The fuel cell according to claim 11 wherein the predetermined lifetime is at least 6000 hours.

16. A method for making a flow field plate for a fuel cell, said method comprising:
providing a flow field plate being made of a plate material, said flow field plate including a plurality of flow channels; and
depositing an outer layer on the plate that makes the flow field plate hydrophilic, wherein depositing an outer layer on the plate includes depositing the layer so that the material of the layer and the thickness of the layer cause hydrofluoric acid within the fuel cell to etch away an outer surface of the layer at a rate so that a clean surface of the layer is continuously exposed, but the layer is not completely etched away over a predetermined lifetime of the fuel cell.

17. The method according to claim 16 wherein depositing an outer layer on the plate includes depositing a metal oxide layer.

18. The method according to claim 17 wherein the metal oxide comprises at least one of SiO₂, HfO₂, ZrO₂, Al₂O₃, SnO₂, Ta₂O₅, Nb₂O₅, MoO₂, IrO₂, RuO₂, metastable oxynitrides, nonstoichiometric metal oxides, oxynitrides and mixtures thereof.

19. The method according to claim 16 wherein depositing an outer layer on the plate includes depositing the outer layer to a thickness between 80-100 nm.

20. The method according to claim 16 wherein the predetermined lifetime is at least 6000 hours.
